(19) United States
(12) Patent Application Publication
(10) Pub. No.: US 2008/0014961 A1
(43) Pub. Date: Jan. 17, 2008

(54) Methods, systems, and computer program products for providing geographically diverse IP multimedia subsystem (IMS) instances

(75) Inventors: Thomas P. Lipps, Cary, NC (US); David M. Sprague, Raleigh, NC (US)

Correspondence Address: JENKINS, WILSON, TAYLOR & HUNT, P. A., 3100 TOWER BLVD., Suite 1200, DURHAM, NC, 27707, US

(73) Assignee: Tekelec

(21) Appl. No.: 11/584,247

(22) Filed: Oct. 20, 2006

Related U.S. Application Data
(60) Provisional application No. 60/830,418, filed on Jul. 12, 2006.

(51) Int. Cl. H04Q 7/20

(52) U.S. Cl. 455/456.1

(57) ABSTRACT

Systems, methods and computer program products for providing geographically diverse Internet protocol multimedia subsystem (IMS) instances. A geographically diverse IMS network element is disclosed herein including an active instance of a first IMS function, being located in a first geographic location, and a standby instance of the first IMS function, being located in a second geographic location different from the first geographic location.

### RELATED APPLICATIONS

This application claims the benefit of U.S. Provisional Patent Application Ser. No. 60/830,418 filed Jul. 12, 2006; the disclosure of which is incorporated herein by reference in its entirety.

### TECHNICAL FIELD

The subject matter described herein relates to methods, systems and computer program products for use in an Internet protocol (IP) multimedia subsystem (IMS). More particularly, the subject matter described herein relates to methods, systems, and computer program products for providing geographically diverse IMS instances.

### BACKGROUND ART

IMS is defined by the Third Generation Partnership Project (3GPP) as a new mobile network infrastructure that enables the convergence of data, speech, and mobile network technology over an IP-based infrastructure. IMS bridges the gap between the existing traditional telecommunications technology and Internet technology, allowing network operators to offer a standardized, reusable platform that can be used to provide services for both mobile networks and landline networks at the same time, providing unique mixtures of services with transparency to the end-user.

The main function of IMS is to set up media communication sessions between users and between users and applications. IMS uses the session initiation protocol (SIP) for initiating, modifying, and terminating an interactive user session that involves multimedia elements, such as video, voice, instant messaging, online games, and virtual reality, and provides the service creator the ability to combine services in the same session and dynamically modify sessions “on the fly” (e.g., adding a video component to an existing voice session). As a result, new and innovative user-to-user and multi-user services become available, such as enhanced voice services, video telephony, chat, push-to-talk, and multimedia conferencing, all of which are based on the concept of a multimedia session.

As used herein, the term “IMS network” refers to a collection of connected entities performing IMS functions. An IMS network may be controlled by an operator, which is typically a business entity such as a telephone company. The set of IMS entities within a particular operator's control may be referred to as an operator's network. The operator may control the operator's network from a network operator's console (NOC).

As used herein, the term “subscriber” refers to an operator's customer who uses the operator's network. Typically, all of an operator's subscribers are assigned to the operator's network. A subset of subscribers in an operator's network may be referred to as a point of presence (POP).

As used herein, the term “IMS network element” (NE) refers to a logical grouping of entities that perform a specific assigned IMS function or group of functions within an IMS network. IMS functions include the call session control function (CSCF), the home subscriber server (HSS) function, the authentication, authorization, and accounting (AAA) function, and application server (AS) functions.

The CSCF is used to process SIP signaling packets in the IMS. It aids in the setup and management of sessions and forwards messages between IMS networks. There are three distinct CSCF functions: proxy CSCF (P-CSCF), interrogation CSCF (I-CSCF), and serving CSCF (S-CSCF). The P-CSCF is the first point of contact for a subscriber connecting to the network; it is the gateway into the IMS network. The P-CSCF implements compression and security. A P-CSCF may be configured to forward requests to a specific I-CSCF, which is the next function in the IMS signaling path. The I-CSCF provides a subscriber location function (SLF), which maps a subscriber to a specific S-CSCF, thus enabling the I-CSCF to route requests to the correct S-CSCF. The I-CSCF also provides a network interconnect function (NIF). The NIF knows how to route requests to other interconnecting networks (via their I-CSCFs). The S-CSCF is the core of the network. The S-CSCF maintains a database for all of the subscribers assigned to a POP. The S-CSCF provides services for the users, such as setting up media communication sessions between users and applications.

The HSS holds key subscriber information and enables users (or servers) to find and communicate with other end users. The AAA authenticates the user, gives access only to valid users, grants the user authority to use certain functions or features available on the IMS network, and tracks user activity for accounting and billing purposes.

Additional IMS functions may also include functions, collectively referred to as application server functions (AS), such as caller ID, call waiting, call holding, push to talk, call forwarding, call transfer, call blocking, malicious caller identification, lawful interception, announcement services, conference call services, voicemail, text to speech and speech to text, location-based services, messaging services and instant messaging, presence information, enumeration (ENUM), and 2-G gateway services.

To increase the reliability of an IMS network, servers in the IMS network may be configured in an active/standby configuration, in which a server operates in active mode while a redundant server operates in standby mode, ready to assume the functions of the active server in the event that the active server should fail or otherwise be deactivated.

FIG. 1 is a block diagram illustrating an example conventional IMS system. In conventional IMS networks, each network element may perform a single IMS function.

In FIG. 1, network elements NE1 100A and NE1′ 100B are a redundant pair, where NE1 100A includes an active instance of an operation, administration, management, and provisioning (OAM&P) node 102A, and NE1′ 100B includes a standby instance of the OAM&P node 102B. As used herein, the term “node” refers to the portion of a network element on which an active or standby instance of an IMS function resides. Network elements NE1 100A and NE1′ 100B are co-located in a single geographic location. Switch 104 connects IMS network 106 either to NE1 100A or to NE1′ 100B.

Network elements NE2 108A and NE2′ 108B are a redundant pair, where NE2 108A includes three active S-CSCF instances 110A, 112A, and 114A, and NE2′ 108B includes three standby S-CSCF instances 110B, 112B, and 114B. Network elements NE2 108A and NE2′ 108B are co-located in geographic location 2. Switch 116 connects IMS network 106 either to NE2 108A or to NE2′ 108B.

Network elements NE3 118A and NE3′ 118B are a redundant pair, where NE3 118A includes an active P-CSCF instance 120A, and NE3′ 118B includes a standby P-CSCF instance 120B. Network elements NE3 118A and NE3′ 118B are co-located in geographic location 3. Switch 122 connects IMS network 106 either to NE3 118A or NE3′ 118B.

If any IMS functional component in the active network element fails or is otherwise deactivated, the active network element will transition to standby mode and the standby network element will become active. In the IMS system illustrated in FIG. 1, the entire network element and included IMS functions are either all in active mode or all in standby mode. For example, if active S-CSCF1 110A fails, network element NE2 108A will transition from active to standby mode, network element NE2′ 108B will transition from standby to active mode, and switch 116 will connect NE2′ 108B, rather than NE2 108A, to IMS network 106.

There are several problems associated with IMS systems that are configured and operate as illustrated in FIG. 1, where the network element and all of its included IMS functions are either all in active mode or all in standby mode. One problem is that when only one IMS function or instance of a function fails, the other IMS functions or instances residing on that network element will be taken out of service by the transition of the entire network element from active to standby mode, even though the other IMS functions or instances were operating correctly. This transition may trigger database update, replication, or other maintenance for each standby IMS function or instance on the network element that becomes active—additional processing that is potentially superfluous. Another problem is that in the event of planned maintenance, testing, or software or hardware upgrades, the entire network element must be deactivated. Thus, even if only one IMS function or instance is upgraded, all IMS functions or instances must be taken offline, causing unnecessary disruption to all functions performed by the network element.

Another problem associated with IMS systems as illustrated in FIG. 1, where the network element and its redundant mate are located in the same geographical location, is that the network element and its redundant mate are both subject to any local site failures such as a loss of power, or damage to the facility where the network element and its redundant mate are located. Under such circumstances, the standby network element cannot fulfill its intended purpose of providing a redundant function to take over when and if the active function fails, since the standby network element also fails for the same reason that the active network element failed.

Accordingly, in light of these difficulties associated with IMS networks, there exists a need for systems, methods, and computer program products for providing network elements with enhanced fault tolerance due to geographic isolation of the active and standby instances of an IMS function, and enhanced flexibility due to switchover at the IMS function level rather than the network element level.

### SUMMARY

According to one aspect, the subject matter described herein includes a geographically diverse Internet protocol multimedia subsystem (IMS) network element (NE). The network element includes an active instance of an IMS function located in one geographic location. The network element also includes a standby instance of the IMS function located in another geographic location.

According to another aspect, the subject matter described herein includes an Internet protocol multimedia system (IMS). The system includes a first network element in a first geographic location, and a second network element in a second geographic location. The first network element includes an active instance of an IMS function, and the second network element includes a standby instance of the IMS function.

According to yet another aspect, the subject matter described herein includes a method of providing a fault-tolerant Internet protocol multimedia subsystem (IMS) network element (NE) by providing an active instance of an IMS function in a first geographic location and providing a standby instance of the IMS function in a second geographic location.

The subject matter described herein for providing an IMS system architecture with flexible, geographically diverse redundancy may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer program product comprising computer executable instructions embodied in a computer readable medium. Exemplary computer readable media suitable for implementing the subject matter described herein include disk memory devices, chip memory devices, programmable logic devices, application specific integrated circuits, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram illustrating a conventional IMS network configured so that each network element implements a single IMS function;

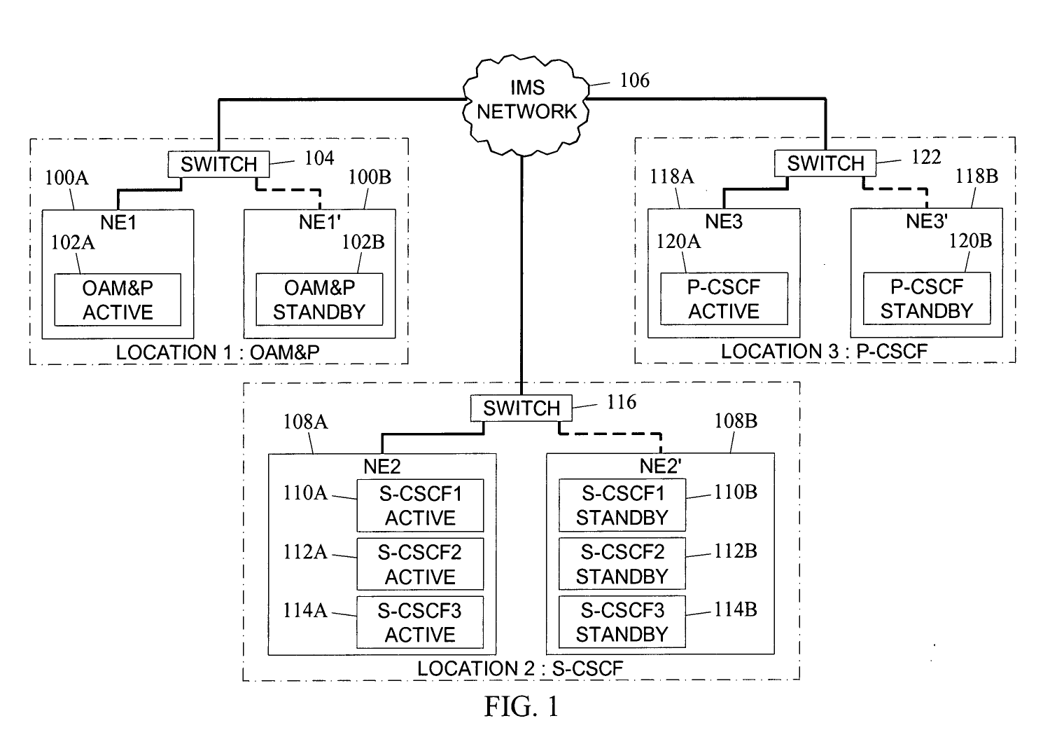

FIG. 2 is a block diagram illustrating an exemplary flexible, geographically diverse IMS network element according to an embodiment of the subject matter described herein;

FIG. 3 is a block diagram illustrating an exemplary IMS network element in 1-active/N-standby configuration according to an embodiment of the subject matter described herein;

FIG. 4 is a block diagram illustrating an exemplary IMS system according to an embodiment of the subject matter described herein; and

FIG. 5 is a flow chart illustrating a method of providing a fault-tolerant IMS network element according to an embodiment of the subject matter described herein.

### DETAILED DESCRIPTION OF THE INVENTION

In order to avoid the difficulties associated with providing redundancy only at the network element level and with locating redundant system elements in the same geographic location, the subject matter described herein includes an IMS network element including a set of IMS functions, wherein each IMS function is implemented as a set of instances in an active/standby operational relationship to each other. A set of instances associated with one IMS function may operate independently of another set of instances associated with another IMS function. In one embodiment, the active and standby instances associated with each IMS function are geographically diverse from each other.

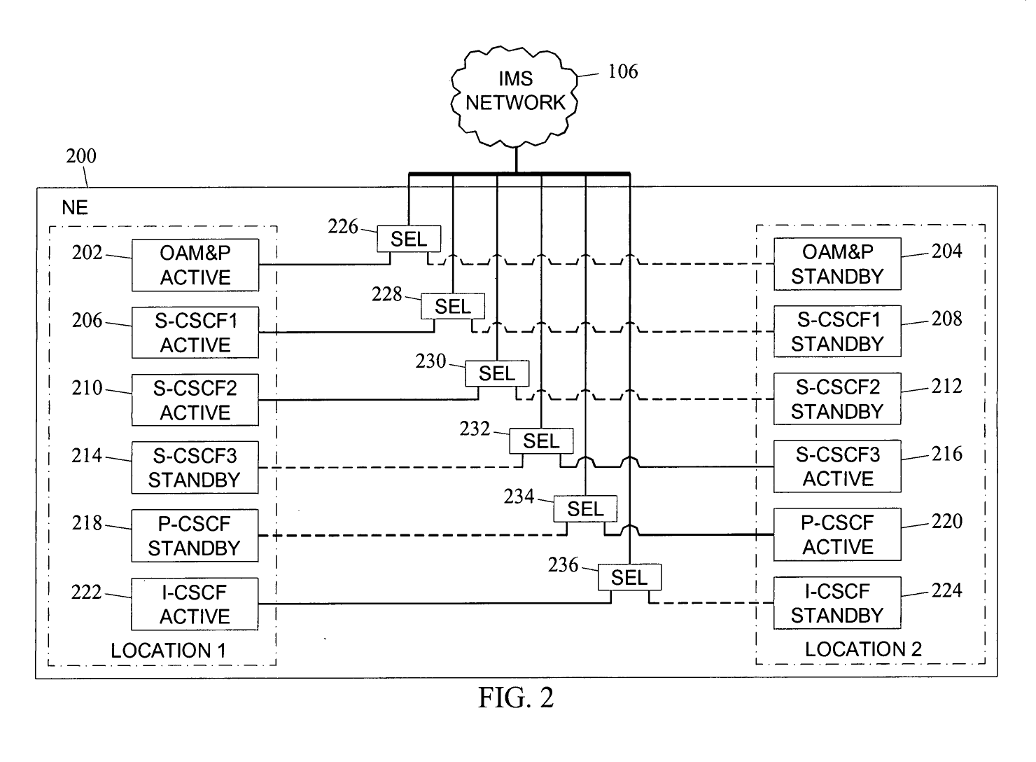

FIG. 2 is a block diagram of an exemplary flexible, geographically diverse IMS network element in accordance with an embodiment of the subject matter described herein. In FIG. 2, network element 200 includes an active instance of the IMS operations, administration, management, and provisioning (OAM&P) function 202, a standby instance of the OAM&P function 204, an active instance of a first IMS serving call session control function (S-CSCF) 206, a standby instance of the first S-CSCF 208, an active instance of a second S-CSCF 210, a standby instance of the second S-CSCF 212, a standby instance of a third S-CSCF 214, an active instance of the third S-CSCF 216, a standby instance of an IMS proxy call session control function (P-CSCF) 218, an active instance of the P-CSCF 220, an active instance of an IMS interrogating call session control function (I-CSCF) 222, and a standby instance of the I-CSCF 224. Although the example illustrated in FIG. 2 includes an OAM&P, three instances of an S-CSCF, an I-CSCF, and a P-CSCF implemented in an IMS network element, the subject matter described herein is not limited to implementing this particular combination and number of IMS functions in an IMS network element. Implementing any one or more IMS functions, and implementing one or more instances of any particular IMS function in an IMS network element is intended to be within the scope of the subject matter described herein.

Each IMS function instance may be configured with its own unique IP address internal to network element 200. As illustrated in FIG. 2, each active/standby pair may be associated with a selection mechanism 226, 228, 230, 232, 234, or 236. In one embodiment, each selection mechanism may utilize a virtual IP address (VIP) to represent both the active instance and the standby instance. Entities on IMS network 106 seeking to communicate with an IMS function within network element 200 may direct such communication to a virtual IP address, and the currently active instance of the IMS function requested may respond to communication directed to that virtual IP address. Thus, switching between active and standby instances may occur at the functional level—for each IMS function instance individually—rather than at the network element level. For example, in FIG. 2, IMS function S-CSCF2 210 is in the active mode (i.e., it responds to the virtual IP address), while its redundant function S-CSCF2 212 is in standby mode (i.e., it ignores commands and requests made to the virtual IP address). Should instance 210 fail or otherwise be deactivated for maintenance, testing, or upgrade, instance 212 becomes active and only instance 212 will respond to communication directed to virtual IP address 230. Similarly, if IMS function P-CSCF1 220 fails, instance 218 becomes active and only instance 218 will respond to communication directed to virtual IP address 234. Regardless of which instance an IMS function request ultimately communicates with, the virtual IP address presented to IMS network 106 does not change. In this way, the switch between active and standby instances within network element 200 would occur invisibly to a user on IMS network 106. An exemplary selection mechanism using virtual IP addresses is linux high availability (linux-HA). The use of other selection mechanisms is intended to be within the scope of the subject matter herein, including other high availability mechanisms, selection using virtual IP addresses, and selection using domain name system, for example.

Each IMS function instance in network element 200 may also have its own unique IP address, separate from the virtual IP address, for administrative or other purposes. In addition, each instance may physically reside in a geographic location which is separate from its corresponding redundant instance. For example, in FIG. 2, instance 202 is in physical location 1 while its redundant instance 204 is in physical location 2. This geographic diversity provides the important benefit that a local failure at location 1, such as a power outage, will not affect the operation of the redundant instances in location 2. Furthermore, each geographic location may contain a mix of active and standby instances, as illustrated in FIG. 2, where physical location 1 includes active instances 202, 206, 210, and 222, and standby instances 214 and 218. Thus, for example, it is possible to deactivate instance 222 for a software upgrade without having to also deactivate currently active instances 202, 206, or 210.

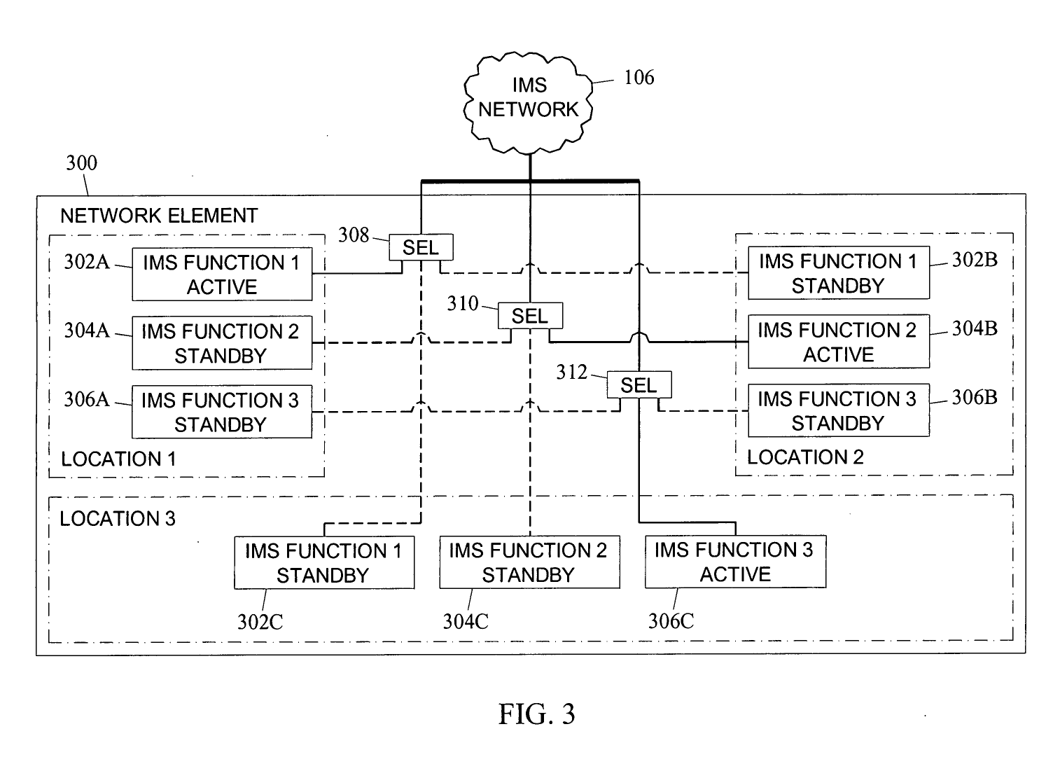

FIG. 3 is a block diagram of an exemplary IMS system in accordance with another embodiment of the subject matter described herein. FIG. 3 illustrates the principle that geographic redundancy is not limited to a single redundancy (1 active/1 standby) scheme, but may be applied to multiple redundancy (1 active/N standby) schemes. In FIG. 3, network element 300 performs three functions, IMS Function 1, IMS Function 2, and IMS Function 3. Network element 300 includes an active instance of IMS Function 1 302A, a first standby instance of IMS Function 1 302B, and a second standby instance of IMS Function 1 302C. Network element 300 also includes an active instance of IMS Function 2 304B, two standby instances of IMS Function 2 304A and 304C, an active instance of IMS Function 3 306C, and two standby instances of IMS Function 3 306A and 306B. As illustrated in FIG. 3, instances 302A, 304A, and 306A exist in geographic location 1, instances 302B, 304B, and 306B exist in geographic location 2, and instances 302C, 304C, and 306C exist in geographic location 3. Selection mechanisms 308, 310, and 312 determine which IMS Function instance will actively communicate with the IMS network 106.

When an active instance fails or is otherwise deactivated, one of the standby instances will become the new active instance through a selection process. This selection process may be a negotiation between the standby instances, for example, or it may be a decision made at some other functional level or by some other functional entity. For example, if the active instance of IMS function 1 302A fails, standby instance 302B may negotiate directly with standby instance 302C to determine which one will become the new active instance. Alternatively, instances 302A, 302B, and 302C may have been pre-programmed with values that indicate each instance's relative priority, in which case, the standby instance with the higher or highest priority would automatically become the new active mode.

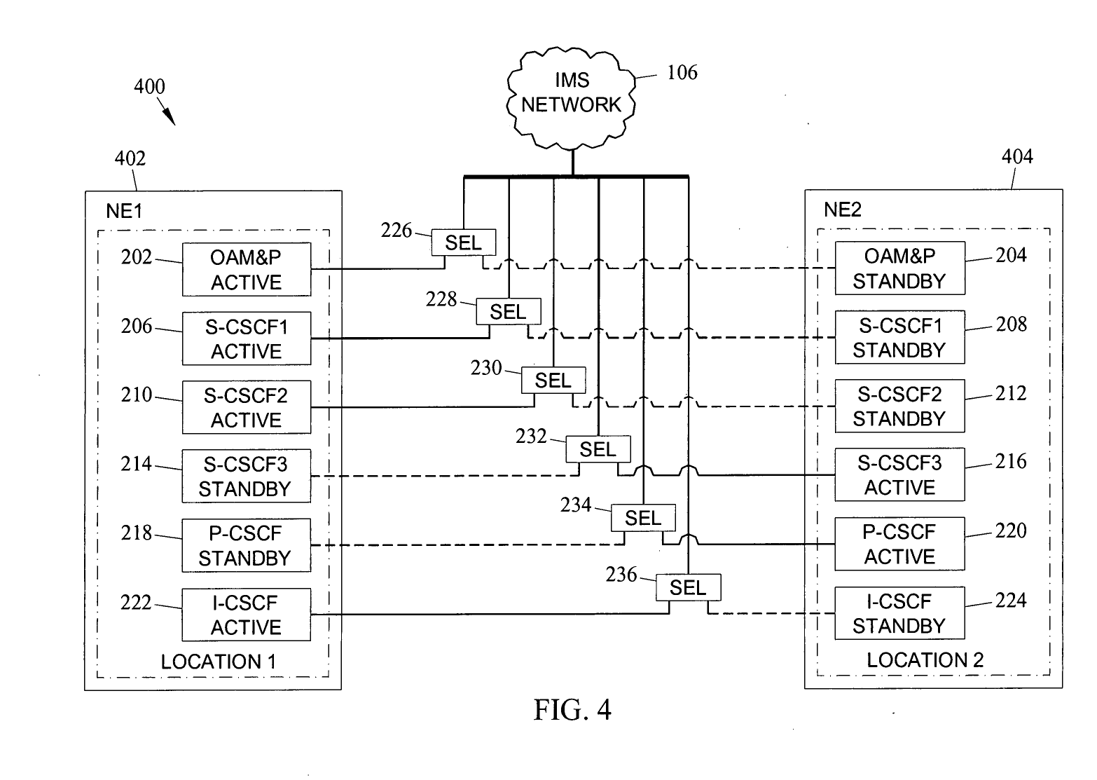

FIG. 4 is a block diagram of an exemplary IMS system in accordance with another embodiment of the subject matter described herein. IMS system 400 includes a first network element (NE1) 402 in one geographic location, and a second network element (NE2) 404 in another geographic location. As illustrated in FIG. 4, NE1 402 and NE2 404 together include mated pairs of IMS function instances—202 mated with 204, 206 mated with 208, 210 mated with 212, 214 mated with 216, 218 mated with 220, and 222 mated with 224—with an active instance of an IMS function residing on one network element and the standby instance of the IMS function residing on the other network element. For example, NE1 402 includes an active instance of an OAM&P function 202, and NE2 404 includes a standby instance of the OAM&P function 204. NE2 404 includes an active instance of a P-CSCF function 220 and NE1 402 includes the standby instance of the P-CSCF function 218.

As illustrated in FIG. 4, each active/standby pair is associated with selection mechanism 226, 228, 230, 232, 234, or 236. In one embodiment, each selection mechanism utilizes a virtual IP address (VIP) to represent both the active instance and the standby instance. Entities on IMS network 106 seeking to communicate with an IMS function within the IMS system 400 may direct such communication to a virtual IP address, and the currently active instance of an IMS function will respond to communication directed to that virtual IP address. The standby instances of the IMS function will not respond to communication directed to that virtual IP address. In FIG. 4, IMS function P-CSCF 220 is in active mode, while its redundant function P-CSCF 218 is in standby mode. A user on IMS network 106 seeking to initiate a session (i.e. to place a call) will first contact the P-CSCF function within the IMS system 400 at virtual IP address 234. Currently active P-CSCF instance 220 will respond to communication directed to virtual IP address 234. Should instance 220 fail or otherwise be deactivated for maintenance, testing, or upgrade, instance 218 would become active and only instance 218 will respond to communication directed to virtual IP address 234. The next user seeking to initiate a session via P-CSCF at virtual address 234 will communicate with instance 218.

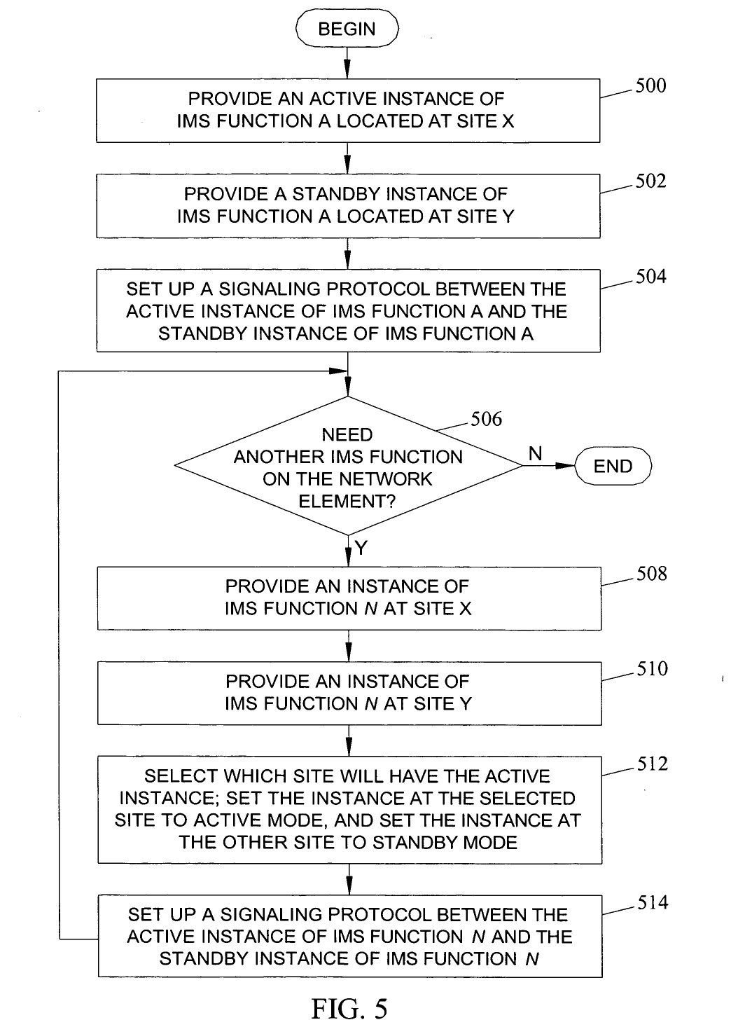

FIG. 5 is a flow chart illustrating exemplary steps for providing a fault-tolerant IMS network element according to an embodiment of the subject matter described herein. Referring to FIG. 5, in step 500, an active instance of an IMS function is provided at a first geographic location, site X. For example, the active instance can be a general purpose processor located at site X, executing a software program to perform P-CSCF functions.

In step 502, a standby instance of the IMS function is provided at a second geographic location, site Y. The standby instance in this example can be a printed circuit board that performs P-CSCF functions in hardware and which is plugged into the backbone of a telecommunication equipment frame located at site Y.

In step 504, a signaling protocol is set up which allows the active and standby instances of the IMS function to monitor each other's operational state. An exemplary signaling protocol is the Linux high-availability (Linux-HA) protocol, wherein each node in an HA cluster sends a periodic “heartbeat” message to every other node. If a standby node fails to receive a heartbeat message from the active node within the allowable period, the standby node assumes that the active node has failed, and the standby node transitions from standby mode to active mode. Extensions to the HA heartbeat protocol may provide for negotiation between available standby nodes to determine which node will become the new active node, provide for signaling that allows for finer control of behavior during failover, such as activation or deactivation of individual IMS functional instances within a node, and provide for remote management and control that allows a management entity to remotely activate or deactivate functional instances.

In step 506, it is determined if additional IMS functions are to be added to the network element. If so, an instance of an additional IMS function is provided at site X (step 508), another instance of the additional IMS function is provided at site Y (step 510), an instance of the additional IMS function at one site is configured as the active instance and the instance of the additional IMS function at the other site is configured as the standby instance (step 512), and the active and standby instances of the additional function are configured to communicate with each other through the signaling protocol (step 514). Steps 506 through 514 are repeated as necessary until all IMS functions for the network element have been instantiated and configured as sets of instances in active/standby relationship.

It will be understood that various details of the invention may be changed without departing from the scope of the invention. Furthermore, the foregoing description is for the purpose of illustration only, and not for the purpose of limitation.

What is claimed is:

1. A geographically diverse Internet protocol multimedia subsystem (IMS) network element, comprising:
(a) an active instance of a first IMS function, being located in a first geographic location; and
(b) a standby instance of the first IMS function, being located in a second geographic location different from the first geographic location.

2. The network element of claim 1 comprising:
(a) a first node which includes the active instance of the first IMS function, the first node being located in the first geographic location; and
(b) a second node which includes the standby instance of the first IMS function, the second node being located in the second geographic location.

3. The network element of claim 1 comprising an active instance of a second IMS function located in the first geographic location and a standby instance of the second IMS function located in the second geographic location.

4. The network element of claim 1 comprising a standby instance of a second IMS function located in the first geographic location and an active instance of the second IMS function located in the second geographic location.

5. The network element of claim 1 wherein the first IMS function comprises a function selected from the group consisting of a proxy call session control function (P-CSCF), an interrogating call session control function (I-CSCF), a serving call session control function (S-CSCF), a home subscriber server (HSS) function, an authentication, authorization, and accounting (AAA) function, and an application server (AS) function.

6. The network element of claim 1 wherein the standby instance of the first IMS function is adapted to detect the failure of the active instance of the first IMS function, and, in response to detecting the failure, the standby instance of the first IMS function is adapted to automatically become active.

7. The network element of claim 6 wherein the standby instance of the first IMS function is adapted to detect the failure of the active instance of the first IMS function and to become active using a signaling protocol for monitoring and exchanging state information with the active instance of the first IMS function.

8. The network element of claim 7 wherein the signaling protocol comprises a heartbeat message communicated between the active instance of the first IMS function and the standby instance of the first IMS function.

9. The network element of claim 7 wherein the active and standby instances of the first IMS function are adapted to send messages to each other over a WAN.

10. The network element of claim 7 wherein the active and standby instances of the first IMS function are adapted to send messages to each other over a local connection.

11. The network element of claim 10 wherein the local connection comprises a bus.

12. The network element of claim 10 wherein the local connection comprises a LAN.

13. An Internet protocol multimedia system (IMS) system, comprising:
(a) a first network element including an active instance of a first IMS function, the active instance being located in a first geographic location; and
(b) a second network element including a standby instance of the first IMS function, the standby instance being located in a second geographic location different from the first geographic location.

14. The system of claim 13 comprising an active instance of a second IMS function located on the first network element and a standby instance of the second IMS function located on the second network element.

15. The system of claim 13 comprising a standby instance of a second IMS function located on the second network element and an active instance of the second IMS function located on the first network element.

16. The system of claim 13 wherein the first IMS function comprises a function selected from the group consisting of a proxy call session control function (P-CSCF), an interrogating call session control function (I-CSCF), a serving call session control function (S-CSCF), a home subscriber server (HSS) function, an authentication, authorization, and accounting (AAA) function, and an application server (AS) function.

17. The system of claim 13 wherein the standby instance of the first IMS function is adapted to detect the failure of the active instance of the first IMS function, whereby the standby instance of the first IMS function automatically becomes active upon the failure of the active instance of the first IMS function.

18. The system of claim 13 wherein the standby instance of the first IMS function is adapted to detect the failure of the active instance of the first IMS function and to become active using a signaling protocol for monitoring and exchanging state information with the active instance of the first IMS function.

19. The system of claim 18 wherein the signaling protocol comprises a heartbeat message communicated between the active instance of the first IMS function and the standby instance of the first IMS function.

20. The system of claim 18 wherein the active and standby instances of the first IMS function are adapted to send messages to each other over a WAN.

21. The system of claim 18 wherein the active and standby instances of the first IMS function are adapted to send messages to each other over a local connection.

22. The system of claim 21 wherein the local connection comprises a bus.

23. The system of claim 21 wherein the local connection comprises a LAN.

24. A method of providing a fault-tolerant Internet protocol multimedia subsystem (IMS) network element, the method comprising:
(a) providing an active instance of a first IMS function, being located in a first geographic location; and
(b) providing a standby instance of the first IMS function, being located in a second geographic location different from the first geographic location.

25. The method of claim 24 comprising:
(a) providing a first node including the active instance of the first IMS function, the first IMS node being located in the first geographic location; and
(b) providing a second node including the standby instance of the first IMS function, the second node being located in the second geographic location.

26. The method of claim 24 wherein operation of the standby instance of the first IMS function is geographically isolated from a failure of the active instance of the first IMS function.

27. The method of claim 24 comprising:
(a) providing an active instance of a second IMS function in the first geographic location; and
(b) providing a standby instance of the second IMS function in the second geographic location.

28. The method of claim 24 comprising:
(a) providing an active instance of a second IMS function in the second geographic location; and
(b) providing a standby instance of the second IMS function in the first geographic location.

29. The method of claim 24 wherein the first IMS function comprises a function selected from the group consisting of a proxy call session control function (P-CSCF), an interrogating call session control function (I-CSCF), a serving call session control function (S-CSCF), a home subscriber server (HSS) function, an authentication, authorization, and accounting (AAA) function, and an application server (AS) function.

30. The method of claim 24 comprising detecting, using the standby instance of the first IMS function, the failure of the active instance of the first IMS function, and, in response to detecting the failure, switching the standby instance of the first IMS function to an active state.

31. The method of claim 30 comprising detecting, using the standby instance of the first IMS function, the failure of the active instance of the first IMS function, and, in response to detecting the failure, switching the standby instance of the first IMS function to an active state using a signaling protocol for monitoring and exchanging state information with the active instance of the first IMS function.

32. The method of claim 31 wherein the signaling protocol comprises communicating heartbeat messages between the active instance of the first IMS function and the standby instance of the first IMS function.

33. The method of claim 31 wherein using the signaling protocol includes sending messages over a WAN.

34. The method of claim 31 wherein using the signaling protocol includes sending messages over a local connection.

35. The method of claim 34 wherein the local connection comprises a bus.

36. The method of claim 34 wherein the local connection comprises a LAN.

37. A computer program product comprising computer-executable instructions embodied in a computer-readable medium for performing steps comprising:
(a) providing an active instance of a first IMS function, the first IMS function being located in a first geographic location; and
(b) providing a standby instance of the first IMS function, the second IMS function being located in a second geographic location different from the first geographic location.

38. The computer program product of claim 37 wherein operation of the standby instance of the first IMS function located in the second geographic location is geographically isolated from a failure of the active instance of the first IMS function located in the first geographic location.

39. The computer program product of claim 37 comprising:
(a) providing an active instance of a second IMS function in the first geographic location; and
(b) providing a standby instance of the second IMS function in the second geographic location.

40. The computer program product of claim 37 comprising:
(a) providing an active instance of a second IMS function in the second geographic location; and
(b) providing a standby instance of the second IMS function in the first geographic location.

41. The computer program product of claim 37 wherein the first IMS function comprises performing a function selected from the group consisting of a proxy call session control function (P-CSCF), an interrogating call session control function (I-CSCF), a serving call session control function (S-CSCF), a home subscriber server (HSS) function, an authentication, authorization, and accounting (AAA) function, and an application server (AS) function.

42. The computer program product of claim 37 comprising detecting, using the standby instance of the first IMS function, the failure of the active instance of the first IMS function, and, in response to detecting the failure, switching the standby instance of the first IMS function to an active state.

43. The computer program product of claim 42 comprising detecting, using the standby instance of the first IMS function, the failure of the active instance of the first IMS function, and, in response to detecting the failure, switching the standby instance of the first IMS function to an active state using a signaling protocol for monitoring and exchanging state information with the active instance of the first IMS function.

44. The computer program product of claim 43 wherein the signaling protocol comprises communicating heartbeat messages between the active instance of the first IMS function and the standby instance of the first IMS function.

45. The computer program product of claim 43 wherein using the signaling protocol includes sending messages over a WAN.

46. The computer program product of claim 43 wherein using the signaling protocol includes sending messages over a local connection.

47. The computer program product of claim 43 wherein the local connection comprises a bus.

48. The computer program product of claim 43 wherein the local connection comprises a LAN.
